(19) United States
(12) Patent Application Publication
(10) Pub. No.: US 2003/0123140 A1
(43) Pub. Date: Jul. 3, 2003

(54) Optical amplifier gain characteristics measurement apparatus and method for measuring the gain of an optical amplifier

(75) Inventor: Masayoshi Tanaka, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/325,882

(22) Filed: Dec. 23, 2002

(30) Foreign Application Priority Data
Dec. 26, 2001 (JP) 2001-395181

(51) Int. Cl. H01S 3/00

(52) U.S. Cl. 359/341.41

(57) ABSTRACT

An optical amplifier gain measurement apparatus has a multi-wavelength light source means at the input of an optical amplifier under measurement, which places the optical amplifier under measurement in the saturated condition, a light source means, which generates light over a broad band for use in measurement of wavelength points other than the wavelengths of the multi-wavelength light source, an optical spectrum analyzer means 19 at the output side of the optical amplifier, and a gain versus wavelength characteristics evaluation calculation means for the optical amplifier under measurement, connected to the optical spectrum analyzer.

### BACKGROUND OF THE INVENTION

1. Field of the Invention

The present invention relates to an optical amplifier gain characteristics measurement apparatus and method for measuring the gain of an optical amplifier, and more specifically to an optical amplifier gain characteristics measurement apparatus and a method for measuring the gain of an optical amplifier which are capable of continuous high-speed and high-accuracy measurement of the gain versus wavelength characteristics of an optical amplifier under measurement, continuously within a wavelength measurement band.

2. Related Art

In the past, in an optical communication system, for example, in wavelength-division multiplexed communication used in large-capacity, long-distance optical communication systems, a variation in level between channels is a cause of signal deterioration, and in long-distance transmission, the characteristics of optical amplifiers that relay optical signals at appropriate intervals was also a great caused of signal deterioration.

Therefore, in addition to the need for the above-noted optical amplifiers to have low-noise and high efficiency, the optical amplifiers are needed to have flat gain versus wavelength characteristics and a wide bandwidth.

For this reason, the evaluation of the gain versus wavelength characteristics of an optical amplifier has been important.

FIG. 4 shows an example of a basic measurement circuit for a method of measuring the gain of an optical amplifier.

That is, according to a method for measuring the gain of an optical amplifier, a minute probe light using a variable wavelength light source 12 is mixed with saturated light from a multi-wavelength light source 10 by an optical coupler 11, the wavelength of the variable wavelength light source 12 being set at each measurement wavelength, and by switching the optical switches 15 and 17, as the input-output probe light spectrum of the optical amplifier under measurement 16 is measured by an optical spectrum analyzer 19 so as to determine the gain.

A method for measuring the gain of an optical amplifier of the past such as shown in FIG. 4, however, had the problem of an increase in the measurement wavelength settings because of the wavelength settings of the variable wavelength light source 12, and the settings and sweeping of the optical spectrum analyzer 19 being repeated, thereby resulting in a commensurate increase in the amount of measurement time, in proportion of such repetition.

Another example of prior art, in the re-published patent publication WO99/43054, is a method for measuring the gain of an optical amplifier that combines a pulse method with a probe method, wherein the conditions in which a pulsed signal light and a probe signal light are superimposed and, in each one of the condition in which the pulse of the signal light is on and the condition in which the pulse of the signal light is off, the input-output optical spectrum of the optical amplifier under measurement for the case of the conditions in which the probe light is superimposed and not superimposed on the signal light being determined and evaluated.

In this method, however, it is difficult to perform continuous, high-accuracy measurement for gain versus wavelength characteristics.

In the Japanese Unexamined Patent Publication (KOKAI) No. H9-43096, there is described a method for calculating the gain of an optical amplifier by determining the light power of each of a probe part and ASE in a measurement system for the case of the light not passing through the optical amplifier and then determining the light power of the probe part and ASE in the measurement system in which light passes through the optical amplifier.

With this method, however, it is difficult to perform continuous, high-accuracy measurement for gain versus wavelength characteristics.

Accordingly, it is an object of the present invention to provide an optical amplifier gain measurement apparatus and a method for measuring the gain of an optical amplifier solving the above-noted problems in the prior art, and capable of continuous, high-accuracy measurement of the gain versus wavelength characteristics of an optical amplifier.

### SUMMARY OF THE INVENTION

In order to achieve the above-noted object, the present invention adopts the following basic technical constitution.

Specifically, a first aspect of the present invention is an optical amplifier gain versus wavelength characteristics measurement apparatus.

And this optical amplifier gain versus wavelength characteristics measurement apparatus of the present invention, minimally has a broadband light source outputting light encompassing all the wavelengths to be measured at the input side of the optical amplifier and an optical spectrum analyzer means at the output side of the optical amplifier.

A second aspect of the present invention is a method for measuring the gain versus wavelength characteristics of an optical amplifier.

And this method of the present invention can be applied to an apparatus for measuring the gain versus wavelength characteristics of an optical amplifier which comprising a broadband light source outputting light encompassing a plurality of wavelengths of a signal light under measurement provided at an input side of the optical amplifier.

And the above-mentioned method of the present invention comprises continuously scanning across the entire wavelength band of the broadband light source, with respect to both of the light from the broadband light source before inputting to the optical amplifier and the light from the broadband light source output from the optical amplifier, executing an optical spectrum analysis thereabout and determining the gain versus wavelength characteristics of the optical amplifier from each one of the optical spectrum analyzer result, thus obtained.

By adopting the configurations noted above, an optical amplifier gain characteristics measurement apparatus and a method for measuring the gain of an optical amplifier according to the present invention are capable of continuous, high-accuracy measurement of the gain versus wavelength characteristics of an optical amplifier.

### BRIEF DESCRIPTIONS OF THE DRAWINGS

FIG. 1 is a block diagram showing the configuration of an example of an optical amplifier gain characteristics measurement apparatus according to the present invention.

FIG. 2 is a drawing showing the configuration of gain versus wavelength characteristics of an optical amplifier according to the present invention.

FIG. 3 is a drawing illustrating a method for measuring the gain versus wavelength characteristics using an optical amplifier gain characteristics measurement apparatus according to the present invention.

FIG. 4 is a block diagram illustrating the configuration of a method for measuring the gain of an optical amplifier in the past.

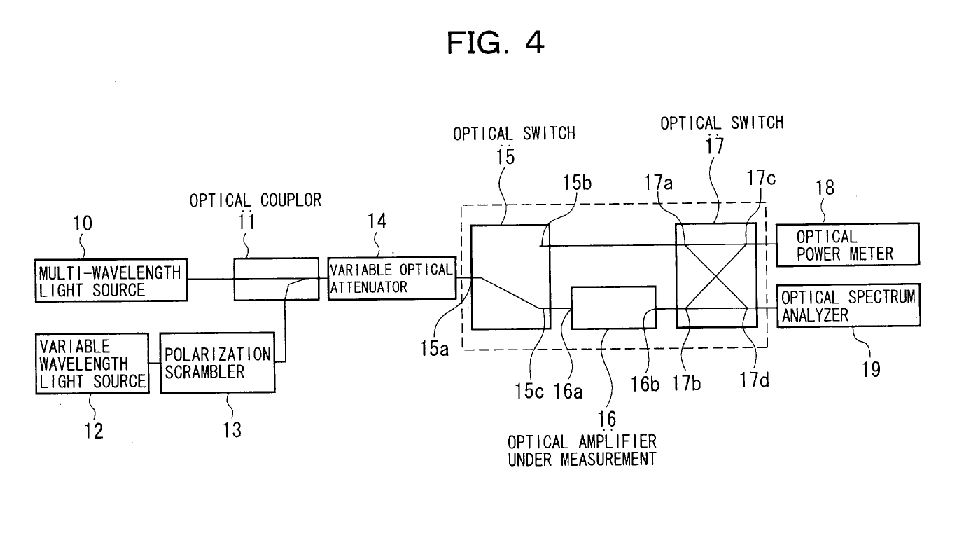

FIG. 5 is a graph showing the gain versus wavelength characteristics of an optical amplifier obtained by a method for measuring the gain of an optical amplifier according to the present invention.

FIG. 6 is a flowchart showing an example of an operating procedure in a method for measuring the gain of an optical amplifier according to the present invention.

### DETAILED DESCRIPTION OF THE PREFERRED EMBODIMENTS

Embodiments of the present invention are described below in detail, with references made to relevant accompanying drawings.

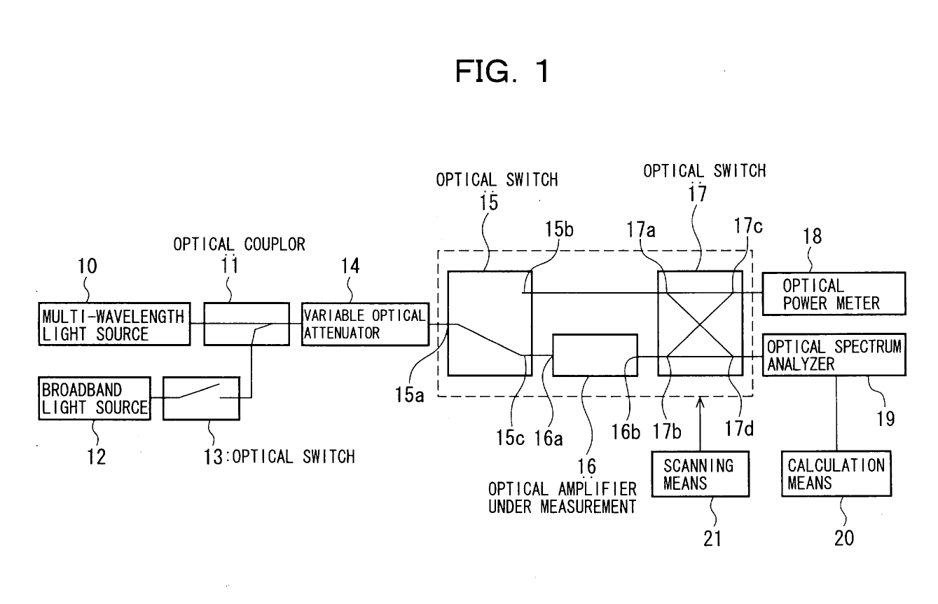

Specifically, FIG. 1 is a block diagram showing an example of an optical amplifier gain characteristics measurement apparatus according to the present invention.

And this drawing shows an optical amplifier gain characteristics measurement apparatus 100 having;

a broadband light source 12 outputting light encompassing all of the measured wavelengths provided at least at the input side of the optical amplifier 16; and

an optical spectrum analyzer 19 provided at the output side of the optical amplifier 16.

Additionally, in the present invention, the optical amplifier gain characteristics measurement apparatus 100 has a function whereby scanning is performed over the entire wavelength of the broadband light of the broadband light source light input to the optical amplifier 16 and broadband light source light output from the optical amplifier 16, respectively, and the results thereof are analyzed by an optical spectrum analyzer, respectively.

It is noted that, the optical amplifier gain characteristics measurement apparatus 100 according to the present invention is not such apparatus which is provided with separate light sources each outputting light having an individual wavelength, respectively, and performs a complicated operation for inputting the light each having the respective wave length, thus prepared into the optical amplifier under measurement 16, respectively, as in the past.

The optical amplifier gain characteristics measurement apparatus 100 according to the present invention is the apparatus in that a broadband light source 12 outputting light having all the wavelengths to be used for gain measurement of the optical amplifier under measurement 16 is provided so that the light output from the broadband light source 12 can be directly input to the optical amplifier under measurement 16.

And in that, scanning operation is performed over the entire wavelength bands of the broadband light source light input into the optical amplifier under measurement 16 and the broadband light source light output from the optical amplifier under measurement 16, respectively, as well as an optical spectrum analysis is performed for both of the lights, using an optical spectrum analyzer, so as to enable to carry out the gain versus wavelength of the optical amplifier under measurement 16.

The present invention, therefore, provides a high-accuracy, high-efficiency optical amplifier gain characteristics measurement apparatus 100 that can, by merely executing scan processing two times, measure the gain of an optical amplifier under measurement over the entire prescribed wavelength band.

In the optical amplifier gain characteristics measurement apparatus 100 according to the present invention, in order to eliminate the influence of natural internally generated light within the optical amplifier 16, the following processes are introduced.

Such as, at first, an optical spectrum analyzer is simply used to perform optical spectrum analysis of only light output from the optical amplifier under measurement 16 itself, without inputting any particular light which is specially prepared into the optical amplifier under measurement 16, and in this analysis, the optical spectrum analyzer is used to obtain spectrum analysis results for both of the light from the above-noted broadband light source and of the light that has passed through the optical amplifier under measurement 16.

And finally, these results are synthesized so that the influence of natural light generated from the optical amplifier under measurement 16 is cancelled.

That is, it is preferable to provide a separate means for canceling the above-noted amount of naturally generated light, and for that reason it is desirable to provide at least a function that scans the light output from the optical amplifier 16 in the case in which the broadband light is not being input thereto over entire the same wavelength as for the broadband light and analyzes the results with a spectrum analyzer.

In the present invention, separate from the above-noted example, in order to cancel the influence of naturally generated light from the above-noted optical amplifier under measurement 16, it is possible for the optical amplifier gain characteristics measurement apparatus be configured to be provided with a light source separate from the broadband light source 12 which generating a light having a minute intensity, separately.

And in that, the analysis operation thereof comprises;

Inputting the weak light from this light source into the optical amplifier under measurement 16;

Scanning the light input to the optical amplifier under measurement 16 and the output light from the optical amplifier under measurement 16, respectively, over the entire wavelength band, as the same operation as is done for the operation with respect to the output light from the above-noted broadband light source 12; and

Analyzing the scanned results with utilizing an optical spectrum analyzer to obtain optical spectrum analysis, which can be used for the object of the present invention.

More specifically, described in terms of the optical amplifier gain characteristics measurement apparatus 100 according to the present invention, the optical amplifier gain characteristics measurement apparatus 100 can adopt the following configuration.

In that, the apparatus is configured so that the gain versus wavelength characteristics of the optical amplifier 16 are measured from optical spectrum analyzer results obtained by individually scanning both all of the wavelengths of light in the broadband light at the input side of the optical amplifier 16 and all of the wavelengths of light in the broadband light at the output side of the optical amplifier 16 for a case in which the broadband light 12 is not input to the optical amplifier, and optical spectrum analyzer results obtained by individually scanning both all of wavelengths of light in the broadband light source light input to the optical amplifier 16 and the broadband light output from the optical amplifier 16 for the case in which the light from the broadband light 12 is input to the optical amplifier 16.

Additionally, it is desirable in the present invention, as shown in FIG. 1, to provide a first optical switch 15 at minimally the input side of the optical amplifier 16, and either to supply measurement light input to the optical amplifier 16 to measure gain versus wavelength characteristics of the optical amplifier 16, selectively to the optical spectrum analyzer 19 via the optical amplifier 16 or directly to the optical spectrum analyzer 16.

As described above, when measuring the gain versus wavelength characteristics of an optical amplifier under measurement, in order to perform a measurement under conditions such as occur when the optical amplifier 16 is actually operating, it is desirable, for example, in place of the above-noted weak light to input to the optical amplifier 16 light that is a mixture of a plurality of wavelengths in order to saturate the optical amplifier 16, and further desirable as one example to provide a multi-wavelength light source means 10 that outputs light that is a mixture of a plurality of wavelengths.

It is desirable that the multi-wavelength light source 10 can output a light band comprising a plurality of lights each having a specific priorly established plurality of wavelength components, and desirable that the light components of each wavelength have substantially the same light intensity.

That is, it is desirable that the light of a plurality of wavelengths included in the above-noted multi-wavelength light source 10 is light of a plurality of wavelengths selected within among all the wavelengths of the broadband light source 12.

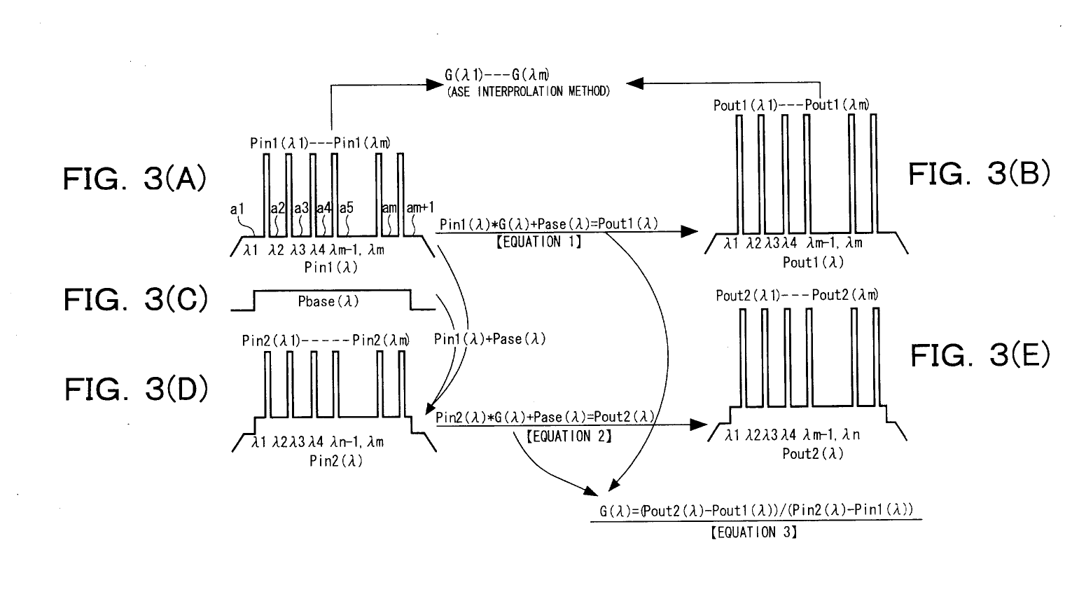

For example, it is preferable that the multi-wavelength light source 10 be configured, as shown in FIG. 3(A) so as to have a uniform distribution over the entire wavelength band of the broadband light source 12, and desirable for example that this light be composed of light at wavelengths at 10 to 12 wavelength positions.

In each portion formed between every two adjacent light wavelength of the light generated from the multi-wavelength light source 10, light component is made up of continuous light having a weak light intensity formed by noise components of light at each wavelength.

That is, as shown in FIG. 3(A), in order to place the optical amplifier under measurement 16 in the saturated condition, 18 wavelengths (λm) within the full wavelength range of the above-noted broadband light source light, each having intensity being substantially identical to each other, are selected, from the light output from the multi-wavelength light source 10, that is, selected as light at wavelengths λ₁ through λ₁₈ substantially at uniform intervals.

And the wavelength bands such as al to am+1, each of which is formed between every adjacent two wavelengths at each of which a light having a respective wavelength exists, are composed of light having minute and weak light intensity, under the influence of noise light existing in the base part of the light each having an individual wavelength, respectively.

Thus, this part can be used to detect naturally generated light (Pase) in the optical amplifier under measurement 16 or cancel the naturally generated light (Pase).

That is, in the present invention, in the case in which light from the broadband light source 12 is not used in a gain measurement operation regarding the optical amplifier 16, the light from the above-noted multi-wavelength light source 10 alone is used in a measurement operation regarding the gain of the optical amplifier 16.

While, in the case in which the light from the broadband light source 12 is used in a gain measurement of the optical amplifier 16, the light from the above-noted multi-wavelength light source 10 is superimposes with the light from the broadband light source 12 and such superposed light is used in an operation of measuring the gain of the optical amplifier 16.

A specific embodiment of an optical amplifier gain measurement apparatus 100 according to the present invention is, for example, an optical amplifier gain measurement apparatus is provided with;

an optical coupler 11 which superimposes multi-wavelength light source light output from the multi-wavelength light source 10 and light that is output from the broadband light source 12, between the optical amplifier 16 and a pair of the multi-wavelength light source 10 and the broadband light source 12; and

a first optical switch 15 at the input side of the optical amplifier 16,

so that the light that passes through the optical coupler 11 is selectively either supplied to the optical spectrum analyzer 19 via the optical amplifier 16 or supplied directly to the optical spectrum analyzer 19.

Another specific embodiment of an optical amplifier gain measurement apparatus 100 can have a configuration in which a variable optical attenuator 14 is provided between the optical coupler 11 and the first optical switch 15, and an optical power meter 18 is provided at the output side of the first optical switch 15 and the optical amplifier 16, the variable optical attenuator 14, responsive to the output of the optical power meter 18, performing adjustment of the input power to the optical amplifier under measurement 16 so as to achieve a rated power.

Yet another preferred example of an optical amplifier gain measurement apparatus 100 according to the present invention can have a configuration in which a second optical switch 17 is provided between the optical coupler 11 and the first optical switch 15, and the optical spectrum analyzer 19 and the optical power meter 18, so that each of the light passing through the first optical switch 15 and the light passing through the optical amplifier 16 can be selectively either sent to the optical power meter 18 or to the optical spectrum analyzer 19.

Another example of the present invention can have a configuration in which a third optical switch 13 is provided between the broadband light source 12 and the optical coupler 11, so as to selectively send light from the broadband light source 12 to the optical coupler 11.

Yet another example of the optical amplifier gain measurement apparatus 100 of the present invention can have a configuration in which the apparatus 100 is provided with;

a scanning means 21 which scans the input light and the output light with respect to the optical amplifier, in the case in which the broadband light source light is not superimposed with the multi-wavelength light source light, and the input light and the output light, in the case in which the broadband light source light is superimposed with the multi-wavelength light source light, over a wavelength band corresponding to the entire wavelength band of the broadband light source;

a optical spectrum obtaining means for obtaining a continuous optical spectrum, while performing each of the scans with respect to the above-mentioned four kinds of lights; and

a processing means for calculating the continuous gain versus wavelength characteristics of the optical amplifier 16 based upon the above four types of optical spectrum.

Therefore, a preferred example of the present invention is an optical amplifier gain versus wavelength characteristics measurement apparatus 100 in which, as shown in FIG. 1, the gain versus wavelength characteristics of the optical amplifier 16 are measured from the following at least two kinds of optical spectrum analyzer results.

Note that, the first kind of the optical spectrum analyzer result is obtained by individually scanning both all of the wavelengths of light in the multi-wavelength light source 10 at the input side of the optical amplifier 6 and all of the wavelengths of light in the multi-wavelength light source 10 at the output side of the optical amplifier for a case in which only the multi-wavelength light source light is input to the optical amplifier.

While the second kind of the optical spectrum analyzer result is obtained by individually scanning both all of wavelengths of superimposed light of the broadband light source 12 and the multi-wavelength light source 10 input to the optical amplifier 16 and all wavelengths of superimposed light of the broadband light source and the multi-wavelength light source output from the optical amplifier for the case in which the broadband light source light and multi-wavelength light source light are superimposed and input to the optical amplifier.

In the present invention, it is preferable that the intensity of the light of the broadband light source be smaller than the intensity of the light at each prescribed wavelength of the multi-wavelength light source.

A specific example of a method of measuring the gain of an optical amplifier 16 by performing a scan operation with respect to each wavelength over the entire prescribed band of light wavelengths is specifically described below.

Using FIG. 1 through FIG. 3, a specific embodiment of the above-noted method for measuring the gain of an optical amplifier according to the present invention, is explained, hereunder.

Note that, in the basic measurement circuit of the method for measuring the gain of an optical amplifier shown in FIG. 1, the optical attenuator 14 is adjusted so that an output value of the optical power meter 18 complies with an input power condition (Pnom), with setting the optical switch 13 in the open condition, and by supplying light of the multi-wavelength light source 10 to the optical power meter 18 passing through the optical coupler 11, variable optical attenuator 14, an input terminal 15a and an output terminal 15b of the first optical switch 15, and an input terminal 17a and output terminal 17c of the second optical switch 17.

Next, the second optical switch 17 is switched to the input terminal 17a and the output terminal 17d, and the intensity of the light at each wavelength over the entire wavelength band is scanned over the above-noted broad band by the optical spectrum analyzer 19, and the input spectrum (Pin1 (λx)) of the overall measurement band is measured by it.

Next, the first optical switch 15 is switched to the input terminal 15a and the output terminal 15c thereof, and the second optical switch 17 is switched to the input terminal 17b and the output terminal 17c, and the output spectrum (Pout1 (λx)) of the overall measurement wavelength band of the optical amplifier under measurement 16 is measured by the optical spectrum analyzer 19.

After the above, the third optical switch 13 is placed in the ON condition, and a light signal that is the superimposition of the output light from the multi-wavelength light source and the output light of the broadband light source ASE 12 is passed through the optical coupler 11, the optical attenuator 14, the input terminal 15a and output terminal 15b of the first optical switch 15, and the input terminal 17a and output terminal 17c of the second optical switch 17, and is input to the optical power meter 18.

By doing this, the optical attenuator 14 is adjusted so that the value of the optical power meter 18 complies with the input power (Pnom) condition.

Next, the second optical switch 17 is switched to the input terminal 17a and the output terminal 17d, and the intensity of the light at each wavelength over the entire wavelength band is scanned over the above-noted broad band by the optical spectrum analyzer 19, and the input spectrum (Pin2 (λx)) of the overall measurement band is measured by it.

Next, the first optical switch 15 is switched to the input terminal 15a an the output terminal 15c, and the second optical switch 17 is switched to the input terminal 17b and the output terminal 17d, then the output spectrum (Pout2 (λx)) of the overall measurement band of the optical amplifier under measurement 16 being measured by the optical spectrum analyzer 19.

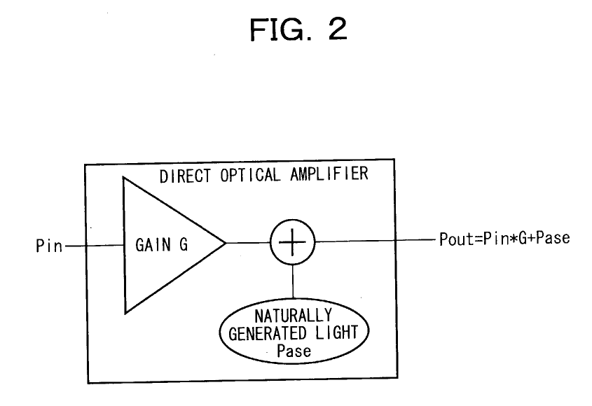

As shown in FIG. 2, because the relationship between the input and the output of the optical amplifier 16 can be expressed as;

Pin*G+Pase=Pout

And thus, in the same manner, the Pin1(λx) and Pout (λx), as well as the Pin2 (λx) and Pout2 (λx) measured with and without superimposition of the broadband light source (ASE light source) light are expressed as follows, by Equation 1 and Equation 2.

Pin1(λx)*G(λx)+Pase(λx)=Pout1(λx) Equation (1)

Pin2(λx)*G(λx)+Pase(λx)=Pout2(λx) Equation (2)

The gain is expressed as in Equation (3) utilizing the above-mentioned Equations (1) and (2), as follows;

G(λx)=(Pout2(λx)−Pout1(λx))/(Pin2(λx)−Pin1(λx)) Equation (3)

Note that, because the broadband ASE light power superimposed on the input of the optical amplifier 16 is very small compared with the powers at each wavelength of the multi-wavelength light source 19 input so as to saturate the optical amplifier 16, at the wavelength points of the multi-wavelength light source (λᵢ, where i=1 to m) the accuracy of the gain expressed by Equation 3 deteriorates.

Given the above, as shown in FIG. 3 the gain G at each wavelength point of the multi-wavelength light source 10 ((λᵢ, where i=1 to m) is determined from the Pin1 (λx, where x=1 to n) and Pout1 (λx, where x=1 to n) for the case in which broadband light ASE is not superimposed, using an appropriate ASE interpolation method.

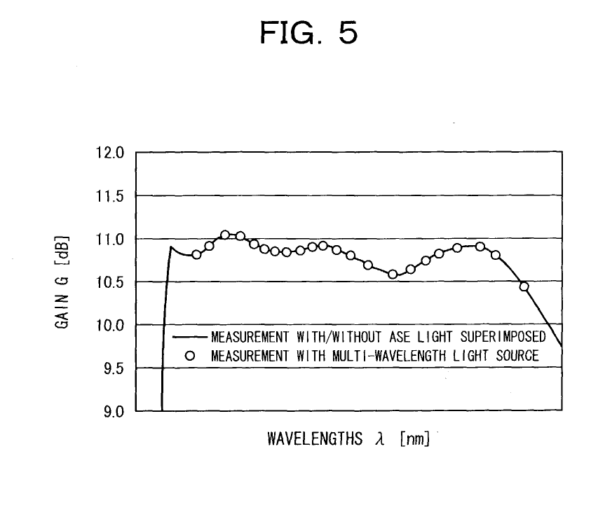

The present invention enables the determination of the continuous gain characteristics over the bandwidth of use of the optical amplifier under measurement 16 as shown in FIG. 5, by means of all respective gains of the multi-wavelength light, obtained at each one of the wavelengths of the multi-wavelength light source light a2 to am, obtained at the short wavelength side al of the wavelength λ1 and obtained at the long wavelength side am+1 of the wavelength λm, and the gains obtained by ASE interpolation at each wavelength of the multi-wavelength light source.

In FIG. 5, the round white marks indicate gain data at each of the wavelength positions of the multi-wavelength light source 10 determined using appropriate interpolation as described above.

The symbols used in the method for measuring the gain of an optical amplifier according to the present invention are as follows.

n: Number of data obtained from the spectrum analyzer with one scan

m: Number of wavelengths of the multi-wavelength light source

Pnom: Measurement condition input power

Pin1 (λx): Input spectrum of only the multi-wavelength light source

Pin2 (λx): Input spectrum with broadband ASE light superimposed on the light of the multi-wavelength light source

Pout1 (λx): Output spectrum of only the multi-wavelength light source

Pout2 (λx): Output spectrum with broadband ASE light superimposed on the light of the multi-wavelength light source

Pbase (λx): Input spectrum of broadband ASE light

Pase (λx): Naturally generated light occurring within the optical amplifier under measurement.

Thus, in the above-noted optical amplifier gain measurement apparatus 100, in order to obtain the gain of the optical amplifier at each light wavelength for the optical amplifier under measurement 16, the following analysis results can be used;

Note that, as the first analysis result obtained by the optical spectrum analyzer, it is determined in such a way in that, in a case in which light of the above-noted broadband light source 12 is not superimposed, such as when the multi-wavelength light output from the multi-wavelength light source 10 shown in FIG. 3(A) is used, the analysis results obtained by the optical spectrum analyzer by scanning the light input into the optical amplifier under measurement 16 over a band corresponding to the overall wavelength band region of the broadband light source 12 is expressed as;

Pin1 (λx) (where x=1 to n).

As the second analysis result obtained by the optical spectrum analyzer, it is determined in such a way in that under the same conditions as mentioned above and as shown in FIG. 3(B), the analysis results obtained by an optical spectrum analyzer by scanning the light output from the optical amplifier under measurement 16 over a band corresponding to the overall band of the above-noted broadband light source is expressed as;

Pout1 (λx) (where x=1 to n).

As the third analysis result obtained by the optical spectrum analyzer, it is determined in such a way in that, the light input to the optical amplifier under measurement 16 for the case in which light of the broadband light source 12 is superimposed on the multi-wavelength light source light input to the optical amplifier under measurement 16, as shown in FIG. 3(C) has a wavelength makeup such as shown in FIG. 3(D) and the analysis results obtained by the above-noted optical spectrum analyzer by scanning with respect to this light over a band corresponding to the overall wavelength band of the broadband light source 12 is expressed as;

Pin2 (λx) (where x=1 to n).

As the fourth analysis result obtained by the optical spectrum analyzer, it is determined in such a way in that, under the same conditions as mentioned above, the analysis results obtained by the above-noted optical spectrum analyzer by scanning light onto which is superimposed the light of the broadband light source 12, as shown in FIG. 3(E) output from the optical amplifier under measurement 16 is expressed as;

Pout2 (λx) (where x=1 to n).

Given the above definitions, because the gain G of the optical amplifier under measurement 16 with respect to each of the wavelengths is calculated with utilizing the above-mentioned four results as;

G (λx)=(Pout2 (λx)−Pout1 (λx))/(Pin2 (λx)−Pin1 (λx)), and thus, by executing the calculation of the above-noted equation by a calculation processing means including an appropriate hardware processing means connected to the optical spectrum analyzer, it is possible by executing four scans to determine the gain of the optical amplifier at each light wavelength both quickly and accurately.

As is clear from the above description, the present invention encompasses the case in which Pin1 (λx) is zero.

Additionally, it is preferable that the present invention be configured so that each of the gains of the optical amplifier under measurement 16 at each wavelength of the multi-wavelength light source be determined from gain information at wavelengths nearby the above-noted wavelengths, by using an interpolation method, separate from the above-noted scanning.

That is, in a method for measuring the gain of an optical amplifier according to the present invention, because the intensity of light in a wavelength band in which each light having the respective wavelength included in the multi-wavelength light from the multi-wavelength light source 10 is existing, has a high intensity, there is a high possibility of not being able to accurately measure the gain.

In the present invention, therefore, with regard to a wavelength position at which light having a wavelength included in the multi-wavelength light from the multi-wavelength light source 10, rather than using the results of measurement by an optical spectrum analyzer obtained by scanning, the gain thereof is obtained by utilizing a known interpolation method and using the measurement results from the above-noted optical spectrum analyzer in a region near the above-noted wavelength.

As is clear from the above description, a method for measuring the gain of an optical amplifier according to the present invention is a method for measuring the gain versus wavelength of the optical amplifier 16, wherein the gain versus wavelength characteristics measurement apparatus minimally is provided with a broadband light source 12 at the input side of the optical amplifier 16, outputting light encompassing all the wavelengths to be measured.

And further wherein, optical spectrum analysis is performed of both light from the above-noted broadband light source 12 but before it is input into the optical amplifier 16, and light of the broadband light source 12 that is output from the optical amplifier 16, by continuous scanning over the entire band of wavelengths of the broadband light source, the gain versus wavelength characteristics of the optical amplifier 16 being determined from the individual obtained spectrum analyzer results.

In the above-noted method for measuring the gain of an optical amplifier, there can be an added operation of performing a scan of light output from the optical amplifier 16 over the same entire wavelength range as the above-noted broadband light source for the case in which the above-noted broadband light source light is not input to the optical amplifier 16, and the results therefrom being analyzed by an optical spectrum analyzer.

In another example of a method for measuring the gain of an optical amplifier according to the present invention, the configuration adopted can be one in which gain versus wavelength characteristics of an optical amplifier 16 are determined from optical spectrum analyzer results obtained by individually scanning both all of wavelengths of light in the broad band at the input side of the optical amplifier 16 and all wavelengths of the light in the broad band at an output side of the optical amplifier 16 for a case in which the broadband light source light is not input to the optical amplifier 16, and optical spectrum analyzer results obtained by individually scanning both all of wave length of light in the broadband light source light with light from a multi-wavelength light source 10 superimposed thereon, and all of wave length of light in the interposed light output from the optical amplifier 16 which is input thereto.

Additionally, another example of the present invention can be configured so as to be minimally provided with a first optical switch 15 at the input side of the optical amplifier 16, measurement light input to the optical amplifier 16 for measuring the gain versus wavelength characteristics of the optical amplifier 16 being either supplied to the optical spectrum analyzer 19 selectively via the optical amplifier 16, or directly supplied to the optical spectrum analyzer 19.

In yet another example of the present invention, it is possible to adopt a configuration in which, between the multi-wavelength light source 10 and the broadband light source 12, and optical amplifier 16, multi-wavelength light source light from the multi-wavelength light source 10 and light output from the broadband light source 12 are selectively superimposed, and wherein either light passing through the optical coupler 11 is selectively supplied to the optical spectrum analyzer 19 via the optical amplifier 16 or light passing through the optical coupler 11 is supplied directly to the optical spectrum analyzer 19.

In a method for measuring the gain of an optical amplifier according to the present invention, it is preferable that the configuration be such that, when calculating gain versus wavelength characteristics, the continuous gain characteristics over a band of use of the optical amplifier under measurement is calculated utilizing the gain between each of the wavelength of the multiple wavelengths of light determined by superimposition of light from the broadband light source 12, the gain at the short-wavelength side of a wavelength λ1 of the multi-wavelength light source light, the gain at the long-wavelength side of a wavelength λm of the multi-wavelength light source light, and each of the gains of the multi-wavelength light source gain determined by the interpolation method.

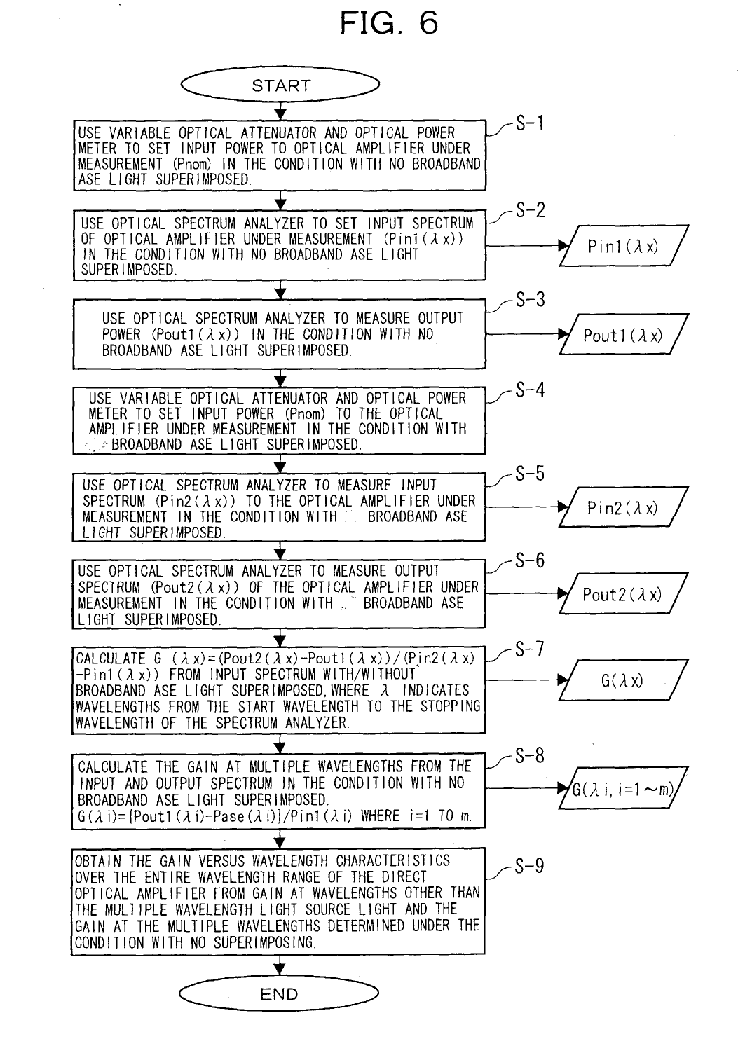

An example of the operating procedure in an example of the above-noted method for measuring the gain of an optical amplifier according to the present invention is described below, with reference made to the flowchart of FIG. 6.

Specifically, in FIG. 6, after the start, at step S-1, a first step of setting an input power (Pnom) of the optical amplifier under measurement utilizing a variable optical attenuator and the optical power meter in a condition with no superimposition of broadband ASE light, is executed, and at step S-2, a second step of using an optical spectrum analyzer to measure the input spectrum (Pin1 (λx)) of the optical amplifier under measurement is performed in a condition with no superimposition of broadband ASE light is executed.

Next, processing proceeds to step S-3, at which a third step of using an optical spectrum analyzer to measure the output spectrum (Pout1 (λx)) of the optical amplifier under measurement in a condition with no superimposition of broadband ASE light, is executed, after which at step S-4, a fourth step of using the variable optical attenuator and the optical power meter to set the input power (Pnom) of the optical amplifier under measurement in a condition with broadband ASE light superimposed, is executed.

After the above, at step S-5, a fifth step of using an optical spectrum analyzer to measure the input spectrum (Pin2 (λx)) of the optical amplifier under measurement in a condition with superimposed broadband ASE light, is executed, after which at step S-6, a sixth step of using an optical spectrum analyzer to measure the output spectrum (Pout2 (λx)) of the optical amplifier under measurement in a condition with superimposition of broadband ASE light, is executed.

Then, at step S-7, a step of calculating the gain G (λx) from the input and output spectrum with and without broadband ASE light superimposition, is executed as follows.

G(λx)=(Pout2(λx)−Pout1(λx))/(Pin2(λx)−Pin1(λx))

In the above, λx indicates all wavelengths from the starting wavelength to the stopping wavelength of the optical spectrum analyzer, and x is any one of 1 to n.

Then, at step S-8, an eighth step of calculating, using the following equation, the gain G (λi) at wavelengths of the multi-wavelength light source is calculated from the input-output spectrum in the condition with no broadband ASE light superimposition, is executed.

G(λi)={Pout1(λi)−Pase(λi)}/Pin1(λi)

In the above, i=1 to m.

Finally, at step S-9, a ninth step of obtaining the gain versus wavelength characteristics over the entire band of the optical amplifier from the gain at wavelengths other than the wavelengths of the multi-wavelength light source determined with and without broadband ASE light superimposition and the gain of the multi-wavelength light source wavelengths determined with no superimposition is executed.

By adopting the technical constitution described in detail above, an optical amplifier gain measurement apparatus and method for measuring the gain of an optical amplifier according to the present invention can measure the gain versus wavelength characteristics of an optical amplifier easily, quickly, and with high accuracy.

The reason this is possible is that, while in general in the case of measuring the gain versus wavelength characteristics of an optical amplifier at a wavelength other than a wavelength using saturated light, measurement is made using a variable wavelength light source as the saturated light with injection of a very small amount of probing light, in order to perform detailed measurement of the wavelength band used by the optical amplifier, it is necessary to repeatedly make settings of the wavelength and power of the variable wavelength light source and measurements of the input and output spectrum of the optical amplifier.

In contrast to this, with the present invention it is possible to measure the gain versus wavelength characteristics of over a short period of time by merely measuring the input and output spectrum over the overall measurement spectrum with two conditions of the amount of broadband ASE light superimpositions.

What is claimed is:

1. An optical amplifier gain versus wavelength characteristics measuring apparatus comprising:
a broadband light source outputting light including a plurality of wavelengths which a signal light under measurement possesses therein, at an input side of an optical amplifier, and an optical spectrum analyzer means at an output side of said optical amplifier.

2. An optical amplifier gain measurement apparatus according to claim 1, wherein said apparatus further comprising a function whereby light of said broadband light source input to said optical amplifier and light of said broadband light source output from said optical amplifier are both scanned over the entire wavelength band of said broadband light, and whereby each of the results therefrom is analyzed by an optical spectrum analyzer, respectively.

3. An optical amplifier gain measurement apparatus according to claim 2, said apparatus further comprising a function that scans a light output from said optical amplifier for the case at lease in which said broadband light source light is not input to said optical amplifier over one and the same wavelengths as used for said broadband light, and analyzes the result therefrom using an optical spectrum analyzer.

4. An optical amplifier gain measurement apparatus according to claim 1, wherein said apparatus being configured so that the gain versus wavelength characteristics of the optical amplifier are measured from optical spectrum analyzer results obtained by individually scanning both all of the wavelengths of light in said broadband light at the input side of the optical amplifier and all of the wavelengths of light in the broadband light at the output side of the optical amplifier for a case in which said broadband light is not input to the optical amplifier, and optical spectrum analyzer results obtained by individually scanning both all of wavelengths of light in said broadband light source light input to said optical amplifier and said broadband light output from said optical amplifier for the case in which the light from said broadband light is input to said optical amplifier.

5. An optical amplifier gain measurement apparatus according to claim 1, wherein said apparatus further comprising a first optical switch at least at an input side of said optical amplifier, wherein measurement light input for the purpose of measuring gain versus wave length characteristics of an optical amplifier are either selectively supplied to said optical spectrum analyzer via said optical amplifier or supplied directly to said optical spectrum analyzer.

6. An optical amplifier gain measurement apparatus according to claim 1, wherein said apparatus further comprising a multi-wavelength light source means outputting light as a mixture of light having a plurality of wavelengths for the purpose of placing an optical amplifier under measurement in the saturated condition.

7. An optical amplifier gain measurement apparatus according to claim 6, wherein said apparatus further configured so that light from said multi-wavelength light source is used alone in an operation of measuring the gain of said optical amplifier in a case in which light from said broadband light source is not used in an operation of measuring the gain of said optical amplifier, or so that said light from said multi-wavelength light source is superimposed with the light from said broadband light source so that said superimposed light being used in an operation of measuring the gain of said optical amplifier in a case in which light from said broadband light source is used for gain measurement of said optical amplifier.

8. An optical amplifier gain measurement apparatus according to claim 6, wherein a plurality of wavelengths of light included in said multi-wavelength light source are made up only of a plurality of wavelengths selected from among all wavelengths band of said broadband light source.

9. An optical amplifier gain characteristic measurement apparatus according to claim 6, wherein said apparatus being configured so that the gain versus wavelength characteristics of the optical amplifier is measured from optical spectrum analyzer results obtained by individually scanning both all of the wavelengths of light in said multi-wavelength light source at the input side of the optical amplifier and all of the wavelengths of light in said multi-wavelength light source at the output side of the optical amplifier for a case in which only said multi-wavelength light source light is input to the optical amplifier, and optical spectrum analyzer results obtained by individually scanning both all of wavelengths of superimposed light of said broadband light source and said multi-wavelength light source input to said optical amplifier and all wavelengths of superimposed light of said broadband light source and said multi-wavelength light source output from said optical amplifier for the case in which said broadband light source light and multi-wavelength light source light are superimposed and input to said optical amplifier.

10. An optical amplifier gain measurement apparatus according to claim 6, wherein an intensity of light of said broadband light source is small compared to an intensity of light of each prescribed wavelength of said multi-wavelength light source.

11. An optical amplifier gain measurement apparatus according to claim 1, wherein a gain G of said optical amplifier under measurement with respect to individual light having the respective wavelengths is calculated using
an analysis result obtained in a case in which light of the above-noted broadband light source is not superimposed, by the optical spectrum analyzer by scanning the input of the optical amplifier under measurement over a band corresponding to the overall wavelength band of the broadband light source expressed as Pin1 (λx) (where x=1 to n),
an analysis result obtained under the same conditions as mentioned above by an optical spectrum analyzer by scanning the light output from the optical amplifier over a band corresponding to the overall band of said broadband light source expressed as Pout1 (λx) (where x=1 to n),
an analysis result obtained in a case in which light of the above-noted broadband light source is superimposed with light input into said optical amplifier under measurement, by the optical spectrum analyzer by scanning the light input into optical amplifier under measurement over a band corresponding to the overall wavelength band of the broadband light source, expressed as Pin2 (λx) (where x=1 to n),
an analysis result obtained under the same conditions as mentioned above by an optical spectrum analyzer by scanning the light output from the optical amplifier and onto which said light of said broadband light source is superimposed, over a band corresponding to the overall band of said broadband light source expressed as Pout2 (λx) (where x=1 to n).

12. An optical amplifier gain measurement apparatus according to claim 1,
wherein in a case in which light of the above-noted broadband light source is not superimposed, analysis result obtained by the optical spectrum analyzer by scanning the input of the optical amplifier under measurement over a band corresponding to the overall wavelength band of the broadband light source is expressed as Pin1 (λx) (where x=1 to n),
wherein under the same conditions an analysis result obtained under the same conditions as mentioned above by an optical spectrum analyzer by scanning the light output from said optical amplifier over a band corresponding to the overall band of said broadband light source expressed as Pout1 (λx) (where x=1 to n),
wherein for a case in which light of the above-noted broadband light source is superimposed with light input into said optical amplifier under measurement, an analysis result obtained by said optical spectrum analyzer by scanning the light input into said optical amplifier under measurement over a band corresponding to the overall wavelength band of the broadband light source, is expressed as Pin2 (λx) (where x=1 to n),
and wherein under the same conditions, an analysis obtained under the same conditions as mentioned above by said optical spectrum analyzer by scanning the light output from said optical amplifier and onto which said light of said broadband light source is superimposed, over a band corresponding to the overall band of said broadband light source, is expressed as Pout2 (λx) (where x=1 to n),
the gain G of said optical amplifier with respect to each of the wavelengths is calculated as G (λx)=(Pout2 (λx)−Pout1 (λx))/(Pin2 (λx)−Pin1 (λx)).

13. An optical amplifier gain measurement apparatus according to claim 11 or claim 12, wherein said equation encompasses a condition in which Pin1 (λx) is zero.

14. An optical amplifier gain measurement apparatus according to claim 6, wherein in a case of using said multi-wavelength light source, individual gains of said optical amplifier under measurement at each wavelength of said multi-wavelength light source are determined from gain information at wavelengths nearly said wavelengths, using an interpolation method, separate from said scanning.

15. An optical amplifier gain measurement apparatus according to claim 1, wherein an optical coupler is provided between said multi-wavelength light source means, said broadband light source means, and said optical amplifier, for the purpose of superimposing multi-wavelength light source light output from said multi-wavelength light source with light output from said broadband light source, and a first optical switch is provided at an input side of said optical amplifier, wherein light passing through said optical coupler is selectively either supplied to said optical spectrum analyzer via said optical amplifier or supplied directly to said optical spectrum analyzer.

16. An optical amplifier gain measurement apparatus according to claim 15, further comprising a variable optical attenuator disposed between said optical coupler and said first optical switch, and a power meter disposed at an output side of said first optical switch and said optical amplifier, wherein said variable optical attenuator, responsive to an output of said optical power meter, performs adjustment of an input power to said optical amplifier under measurement so as to achieve a prescribed power input to said optical amplifier under measurement.

17. An optical amplifier gain measurement apparatus according to claim 16, further comprising a second optical switch between said optical coupler, said first optical switch and said optical spectrum analyzer, said optical power meter, wherein light passing through said first optical switch and light passing through said optical amplifier are selectively either sent to said optical power meter or said optical spectrum analyzer.

18. An optical amplifier gain measurement apparatus according to claim 14, further comprising a third optical switch disposed between said broadband light source and said optical coupler, wherein light from said broadband light source is selectively either sent to said optical coupler.

19. An optical amplifier gain measurement apparatus according to claim 1, wherein a gain versus wavelength characteristics evaluation measurement means comprises
a calculation means, which calculates continuous gain versus wavelength characteristics of said optical amplifier from four types of spectrum, comprising input and output spectrum with respect to the optical amplifier for the case in which the broadband light source is not superimposed with said multi-wave lengths light source and input and output spectrum with respect to the optical amplifier for the case in which said broadband light source is superimposed with said multi-wave lengths light source, and
a scanning means, which scans the entire wavelength band of, said broadband light source.

20. A method for measuring the gain versus wavelength characteristics of an optical amplifier, wherein in an apparatus for measuring the gain versus wavelength characteristics of an optical amplifier, a broadband light source outputting light encompassing a plurality of wavelengths of a signal light under measurement is provided at an input side of said optical amplifier, whereby with respect to both light from said broadband light source before inputting to said optical amplifier and light from said broadband light source output from said optical amplifier an optical spectrum analysis is executed, by performing a continuous scan across the entire wavelength band of said broadband light source, the gain versus wavelength characteristics of said optical amplifier being determined from each optical spectrum analyzer result.

21. A method for measuring the gain of an optical amplifier according to claim 20, wherein said method further comprising an additional step of performing a scan of output light from said optical amplifier across one and the same total wavelengths as said broadband light source for the case in which light of the broadband light source is not input to said optical amplifier, and analyzing the results thus obtained by an optical spectrum analyzer.

22. A method for measuring the gain versus wavelength characteristics of an optical amplifier according to claim 20, wherein gain versus wavelength characteristics of an optical amplifier are determined from optical spectrum analyzer results obtained by individually scanning both all of wavelengths of light in said broad band at the input side of said optical amplifier and all wavelengths of said light in said broad band at an output side of said optical amplifier for a case in which said broadband light source light is not input to the optical amplifier, and optical spectrum analyzer results obtained by individually scanning both all of wave length of light in said broadband light source light with light from a multi-wavelength light source superimposed thereon, and all of wave length of light in said interposed light output from said optical amplifier which is input thereto.

23. A method for measuring the gain of an optical amplifier according to claim 20, wherein said optical amplifier measurement apparatus is provided at least with a first optical switch at an input side of said optical amplifier, and wherein said method comprising the steps of selectively supplying measurement light input to said optical amplifier for measuring gain versus wavelength characteristics of said optical amplifier either to said optical spectrum analyzer via said optical amplifier or directly to said optical spectrum analyzer.

24. A method for measuring the gain of an optical amplifier according to claim 20, wherein said method further comprising a step of inputting light that is a mixture of light having a plurality of wavelengths for the purpose of placing said optical amplifier in a saturated condition, at input side of said optical amplifier.

25. A method for measuring the gain of an optical amplifier according to claim 24, wherein said method using light of a plurality of wavelengths included in said broadband light source which being only consisted of a plurality of lights each having the respective wavelengths selected from among all wavelength band of said broadband light source.

26. A method for measuring the gain of an optical amplifier according to claim, wherein said method further comprising a step of setting an intensity of light of said broadband light source at a level being small compared with an intensity of light at each prescribed wavelength of said multi-wavelength light source.

27. A method for measuring the gain of an optical amplifier according to claim 20, wherein a gain G with respect to light having wavelengths of said optical amplifier under measurement is calculated using an analysis result obtained in a case in which light of the above-noted broadband light source is not superimposed, by the optical spectrum analyzer by scanning the input of the optical amplifier under measurement over a band corresponding to the overall wavelength band of the broadband light source expressed as Pin1 (λx) (where x=1 to n),
an analysis result obtained under the same conditions as mentioned above by an optical spectrum analyzer by scanning the light output from the optical amplifier over a band corresponding to the overall band of said broadband light source expressed as Pout1 (λx) (where x=1 to n),
an analysis result obtained in a case in which light of the above-noted broadband light source is superimposed with light input into said optical amplifier under measurement, by the optical spectrum analyzer by scanning the light input into optical amplifier under measurement over a band corresponding to the overall wavelength band of the broadband light source, expressed as Pin2 (λx) (where x=1 to n),
an analysis result obtained under the same conditions as mentioned above by an optical spectrum analyzer by scanning the light output from the optical amplifier and onto which said light of said broadband light source is superimposed, over a band corresponding to the overall band of said broadband light source expressed as Pout2 (λx) (where x=1 to n).

28. A method for measuring the gain of an optical amplifier according to claim 20, wherein in a case in which light of the above-noted broadband light source is not superimposed, analysis result obtained by the optical spectrum analyzer by scanning the input of the optical amplifier under measurement over a band corresponding to the overall wavelength band of the broadband light source is expressed as Pin1 (λx) (where x=1 to n),
wherein under the same conditions an analysis result obtained under the same conditions as mentioned above by an optical spectrum analyzer by scanning the light output from said optical amplifier over a band corresponding to the overall band of said broadband light source expressed as Pout1 (λx) (where x=1 to n),
wherein for a case in which light of the above-noted broadband light source is superimposed with light input into said optical amplifier under measurement, an analysis result obtained by said optical spectrum analyzer by scanning the light input into said optical amplifier under measurement over a band corresponding to the overall wavelength band of the broadband light source, is expressed as Pin2 (λx) (where x=1 to n),
and wherein under the same conditions, an analysis obtained under the same conditions as mentioned above by said optical spectrum analyzer by scanning the light output from said optical amplifier and onto which said light of said broadband light source is superimposed, over a band corresponding to the overall band of said broadband light source, is expressed as Pout2 (λx) (where x=1 to n),
the gain G of said optical amplifier with respect to each of the wavelengths is calculated as G (λx)=(Pout2 (λx)−Pout1 (λx))/(Pin2 (λx)−Pin1 (λx)).

29. A method for measuring the gain of an optical amplifier according to claim 27, wherein said equation encompasses a condition in which Pin1 (λx) is zero.

30. A method for measuring the gain of an optical amplifier according to claim 20, wherein in a case of using said multi-wavelength light source, individual gains of said optical amplifier under measurement at each wavelength of said multi-wavelength light source are determined from gain information at wavelengths nearly said wavelengths, using an interpolation method, separate from said scanning.

31. A method for measuring the gain of an optical amplifier according to claim 20, wherein between said multi-wavelength light source means, said broadband light source means, and said optical amplifier, multi-wavelength light source light output from said multi-wavelength light source is superimposed with light output from said optical amplifier, and wherein said light passing through said optical coupler is selectively either supplied to said optical spectrum analyzer via said optical amplifier or supplied directly to said optical spectrum analyzer.

32. A method for measuring the gain of an optical amplifier according to claim 20, wherein when calculating gain versus wavelength characteristics, the continuous gain characteristics over a band of use of the optical amplifier under measurement is calculated utilizing the gain between each of the wavelength of said multiple wavelengths of light determined by superimposition of light from said broadband light source, the gain at the short-wavelength side of a wavelength λ1 of the multi-wavelength light source light, the gain at the long-wavelength side of a wavelength λm of the multi-wavelength light source light, and each of the gains of the multi-wavelength light source gain determined by said interpolation method.

33. An optical amplifier gain measurement apparatus comprising:
a multi-wavelength light source means;
a broadband light source means;
an optical coupler disposed between said multi-wavelength light source means and the broadband light source means and an optical amplifier for the purpose of superimposing multi-wavelength light source light output from said multi-wavelength light source means and light output from said broadband light source;
a first optical switch disposed at an input side of said optical amplifier, an optical spectrum analyzer disposed at an output side of said optical amplifier; and
a second optical switch, which selectively supplies light passing through said optical coupler either to said optical spectrum analyzer via said optical amplifier or directly to said optical spectrum analyzer.

34. An optical amplifier gain measurement apparatus according to claim 33, wherein said apparatus further comprising a variable optical attenuator disposed between said optical coupler and said first optical switch, and an optical power meter disposed at an output side of said optical amplifier and further wherein said variable optical attenuator adjusting an input power input to said optical amplifier device under measurement, in response to said output of said optical power meter so as to set said input power thereto at a prescribed rated power.

35. An optical amplifier gain measurement apparatus according to claim 33, wherein said apparatus further comprising a second optical switch between said optical coupler, said first optical switch and said optical spectrum analyzer, said optical power meter, wherein light passing through said first optical switch and light passing through said optical amplifier are selectively either sent to said optical power meter or said optical spectrum analyzer.

36. An optical amplifier gain measuring apparatus according to claim 33, wherein said apparatus further comprising a third optical switch disposed between said broadband light source and said optical coupler, wherein light from said broadband light source is selectively either sent to said optical coupler.
